(19) United States
(12) Patent Application Publication
(10) Pub. No.: US 2026/0292023 A1
(43) Pub. Date: Sep. 24, 2026

(54) Synchronized Data Lifecycle Management

(71) Applicant: NetApp, Inc., San Jose, CA (US)

(72) Inventors: Nathan Daniel Hammernik, Erie, CO (US); Ashwin Palani, Apex, NC (US); Joseph Ray Thomas, III, Arvada, CO (US); Christopher Lee Cason, Golden, CO (US)

(21) Appl. No.: 19/088,342

(22) Filed: Mar. 24, 2025

(51) Int. Cl. H04L 67/1095; G06F 9/48

(52) U.S. Cl. CPC H04L 67/1095; G06F 9/485

(57) ABSTRACT

The technology disclosed herein enables two-way synchronization between a remote data lifecycle manager and agents (e.g., custom resources and controllers) in the computing environments being managed. In a particular example, a method includes executing a data lifecycle manager external to the cluster and executing an agent of the data lifecycle manager on a node within the cluster. A watcher of the control plane monitors events for resources in the cluster. Upon identifying an event, the watcher establishes a connection with the data lifecycle manager and transmits a notification about the event. This transmission allows the data lifecycle manager to manage data lifecycles in the cluster based on the notification.

### TECHNICAL FIELD

Techniques for data lifecycle management for workloads in a computing cluster (e.g., cluster of Kubernetes nodes) are provided. More specifically, techniques are provided for synchronization between remote data lifecycle manager and agents (e.g., custom resources) in the computing environments being managed.

### BACKGROUND

Data lifecycle management solutions are pivotal in ensuring the protection, backup, replication, and migration of workloads across computing environments, such as Kubernetes computing clusters. Such solutions allow system administrators to easily manage their data, create instant application clones, and execute comprehensive protection strategies. Traditionally, these lifecycle management tools operated remotely, interfacing with their respective environments through Application Programming Interfaces (APIs) to perform tasks such as snapshots and backups. These traditional configurations require constant, granular communication between the remote management tool and the local environment, leading to scalability and reliability challenges due to the continuous need for active connections.

Recently, there has been a shift towards embedding business logic (e.g., high-level policies for a business, or other entity, regarding the performance of data lifecycle management, such as when to backup applications, take snapshots, etc.) directly within the computing environments they manage. While high-level control remains centralized to ensure consistency of business logic application across environments, the execution of specific tasks may now be implemented natively within the local environment itself. This means data lifecycle management tasks for the business logic operates alongside the workloads the logic protects, even residing on the same physical servers. Specifically, this recent shift of embedding the business logic directly within the computing environments being managed involves implementing the business logic as a custom resource within the local environment. This local resource performs operations like snapshots, backups, and cloning under the direction of the central control layer.

Despite this advancement, synchronization between the central control and the locally managed resources remains a challenging and complex task due to the distributed nature of their communications. Additional improvements are needed to ensure that lifecycle management tasks performed on resources in a local environment are accurately reflected at the centralized controller.

### SUMMARY

The technology disclosed herein enables two-way synchronization between a remote data lifecycle manager and agents (e.g., custom resources) in the computing environments being managed. In a particular example, a method includes executing a data lifecycle manager external to the cluster and executing an agent of the data lifecycle manager on a node within the cluster. A watcher of the control plane monitors events for resources in the cluster. Upon identifying an event, the watcher establishes a connection with the data lifecycle manager and transmits a notification about the event. This transmission allows the data lifecycle manager to manage data lifecycles in the cluster based on the notification.

In another example, a system is provided for data lifecycle management for nodes in a cluster of a distributed application environment. The nodes in the cluster are configured to execute pods managed by a Kubernetes installation for an application in the distributed application environment. A node of the nodes in the cluster is configured to execute a watcher for a data lifecycle manager based in a cloud external to the cluster. The watcher is a Kubernetes informer. Additionally, a pod executes in the nodes as an agent of the data lifecycle manager. The agent is configured to determine that a cloud state of the cluster at the data lifecycle manager indicates a resource in the cluster is pending and to perform tasks in the cluster to create the resource. The watcher is configured to determine that a local state of the cluster maintained by the agent indicates the resource is in the cluster and to notify the data lifecycle manager that the resource exists in the cluster.

In a further example, an apparatus is provided for data lifecycle management for nodes in a cluster of a distributed application environment. The apparatus includes one or more computer readable storage media, and one or more processing systems operatively coupled with the one or more computer readable storage media. The program instructions are stored on the one or more computer readable storage media that, when read and executed by the processing system, direct the apparatus to receive a resource change for the cluster from a user. The resource change adds a new resource to the cluster and generates an identifier for the new resource that identifies the new resource relative to other resources associated with other identifiers. This identifier is associated with the new resource in an entry of a cloud state database storing a state of the cluster, wherein the entry indicates the new resource is pending. The apparatus synchronizes the cloud state database with a local state database maintained by an agent in the cluster, wherein the agent performs tasks in the cluster to create the new resource having the identifier in the cluster. After the new resource is created, the apparatus again synchronizes the cloud state database with the local state database to update the entry to indicate the new resource is no longer pending.

### BRIEF DESCRIPTION OF THE DRAWINGS

FIG. 1 illustrates an implementation for synchronizing resource information between a computing cluster and an external data lifecycle manager.

FIG. 2 illustrates an operation to synchronize resource information between a computing cluster and an external data lifecycle manager.

FIG. 3 illustrates an operational scenario for synchronizing resource information between a computing cluster and an external data lifecycle manager.

FIG. 4 illustrates an operational scenario for synchronizing resource information between a computing cluster and an external data lifecycle manager.

FIG. 5 illustrates an operational scenario for synchronizing resource information between a computing cluster and an external data lifecycle manager.

FIG. 6 illustrates an operational scenario for synchronizing resource information between a computing cluster and an external data lifecycle manager.

FIG. 7 illustrates an operational scenario for synchronizing resource information between a computing cluster and an external data lifecycle manager.

FIG. 8 illustrates an operational scenario for synchronizing resource information between a computing cluster and an external data lifecycle manager.

FIG. 9 illustrates an operation to synchronize resource information between a computing cluster and an external data lifecycle manager.

FIG. 10 illustrates a computing cluster for synchronizing resource information between a computing cluster and an external data lifecycle manager.

FIG. 11 illustrates an operational scenario for synchronizing resource information between a computing cluster and an external data lifecycle manager.

FIG. 12 illustrates a computing system for synchronizing resource information between a computing cluster and an external data lifecycle manager.

### DETAILED DESCRIPTION

The technology disclosed herein enables two-way synchronization between a remote data lifecycle manager and agents (e.g., a controller that can use custom resources to ensure that a desired state is achieved) in the computing environments being managed. The data lifecycle manager provides operational oversight and control of a company's data to ensure the data is secure, managed efficiently, and in compliance with various laws, regulations, and policies. The data life cycle manager may handle automated or externally scheduled (e.g., periodic) or one-time requests or actions for specific data management (e.g., take a snapshot). Data has a lifecycle that goes through various stages. Each of these stages in the data lifecycle may need various actions, management process, and handling. Common examples of stages in a data lifecycle include, but are not limited to, creation, storage, usage, distribution, retention, deletion, and the like.

The synchronization mechanism and agent described below allow a control layer for a data lifecycle manager to remain external to a computing cluster without requiring a persistent connection between the data lifecycle manager and the cluster. Previously, an external (e.g., in the cloud) data lifecycle manager would have to maintain a connection with the cluster so that the data lifecycle manager can keep itself up to date regarding the current status of resources in the cluster. Likewise, that connection was necessary for the data lifecycle manager to instruct the cluster to direct lifecycle management tasks and ensure the tasks were completed.

In contrast, the cloud-based data lifecycle manager described below employs a watcher in the cluster to provide cluster status updates and an agent in the cluster to direct lifecycle management tasks. The agent may be a software agent (or controller) that acts on behalf of the data lifecycle manager by autonomously performing tasks, making decisions (e.g., based on rules), and/or interacting with other components (hardware or software). The agent, in some cases, can act upon or use a custom resource in a Kubernetes environment to ensure that the desired state specified by the custom resource is achieved and/or maintained. The custom resource is an extension of the Kubernetes API and allows user to define and manage user-created object types. A custom controller of the agent may monitor for changes at the custom resource (e.g., monitors for new resource definitions and management instructions) and takes the actions necessary to implement the changes in the cluster. For example, if the custom resource defines a snapshot of a database should be created, the custom controller will identify the definition and perform tasks necessary to create the snapshot.

A connection with the cluster is only necessary when the data lifecycle manager is communicating with the watcher or agent. Any extra load imposed on the cluster to execute the watcher and agent is negligible relative to the resources previously required to maintain an open connection between the data lifecycle manager and the cluster. Moreover, the watcher and agent improve reliability of lifecycle management because tasks can still be completed during situations where a connection cannot be maintained (e.g., during a network outage).

In an example using a Kubernetes cluster, the watcher may be a Kubernetes informer while the agent may include a Kubernetes custom resource and a custom controller. A Kubernetes informer is a component that monitors the state of resources and changes within the computing cluster. It acts as an intermediary between an application and the Kubernetes Application Programming Interface (API), helping controllers stay updated with the current state of the cluster by efficiently managing resource updates and reducing the load on the API server. The use of an event-driven model is at least one way in which an informer can be so efficient. Being event driven means an informer only reacts to changes in the cluster rather than continuously polling for updates, which reduces unnecessary CPU and network usage. Additionally, an informer maintains a local cache of the resources they are watching. This cache is kept up to date with the latest state from the Kubernetes API server, minimizing the need for frequent API calls.

Utilization of a second informer (the watcher) in addition to the existing informer(s) in a Kubernetes cluster enhances reliability of the external data lifecycle manager significantly. The external data lifecycle manager no longer needs to maintain active connections with the cluster to perform tasks such as snapshots, backups, and other operations. Instead, the data lifecycle manager need only establish brief communication with the watcher to synchronize the current state of the cluster. This brief communication reduces the demand on communication resources and frees up connection resources for other tasks.

The cost of implementing a second informer given the efficiencies of informers described above is minimal compared to the benefits of improved reliability and efficiency. For instance, the external data lifecycle manager does not need to maintain constant active connections with the cluster to continuously query the cluster for status updates. This reduction in constant connection requirements not only saves resources but also enhances the overall efficiency of the cluster operations.

Additionally, using the second informer enables the external data lifecycle manager to be notified when changes initiated by the data lifecycle manager itself have been completed without the data lifecycle manager having to constantly check in with the cluster. The data lifecycle manager in a Kubernetes example may be a Kubernetes custom resource. Custom resources extend the Kubernetes API, allowing you to define your own resource types. When designed well, a custom resource can be as efficient as native Kubernetes resources, which, like the second informer, minimizes the cost of implementing a custom resource on behalf of the data lifecycle manager. The external data lifecycle manager can interact with the custom resource to indicate a change in the cluster. After defining the change in the custom resource, a custom controller for the custom resource makes. With the custom controller handling the change, the data lifecycle manager need not maintain a connection with the cluster direct tasks to implement the change and receive confirmation that the tasks were completed. Instead, the custom controller handles the tasks itself, and the data lifecycle manager can wait for the watcher (i.e., the second informer) to notify the data lifecycle manager when changes occur, allowing the data lifecycle manager to confirm the changes reflect the changes requested by the data lifecycle manager.

Various embodiments of the present technology provide for a wide range of technical effects, advantages, and/or improvements to computing systems and components. For example, various embodiments may include one or more of the following technical effects, advantages, and/or improvements: 1) non-routine and unconventional to reduce dependency and active connection between clusters and external managers; 2) integration to the workflow of an external data lifecycle manger to enhance reliability and consistency of stateful applications; 3) support for a high availability configuration that deploys multiple custom resources within a single cluster enabling local backup and restoration without the need for an external back controller; 4) non-routine and unconventional communication protocols to allow external data lifecycle manager to control, and stay informed about, a cluster's state; 5) non-routine and unconventional use of unique identifiers to confirm the creation, synchronization, and tracking of new resources; 6) unique leveraging of custom resource definitions to define and manage resource types to data management (e.g., backup and restore, disaster recovery, data cloning, application mobility, policy management, etc.); 7) unique distributed system architecture that allows for the remote data lifecycle managers to remain informed about the state of the cluster without constant communication; 8) non-routine and unconventional synchronization process that ensures changes created at the lifecycle data manager and/or cluster are communicated and implemented; and/or 9) utilization of unique synchronization mechanism and algorithms to reduced dependency on constant connection.

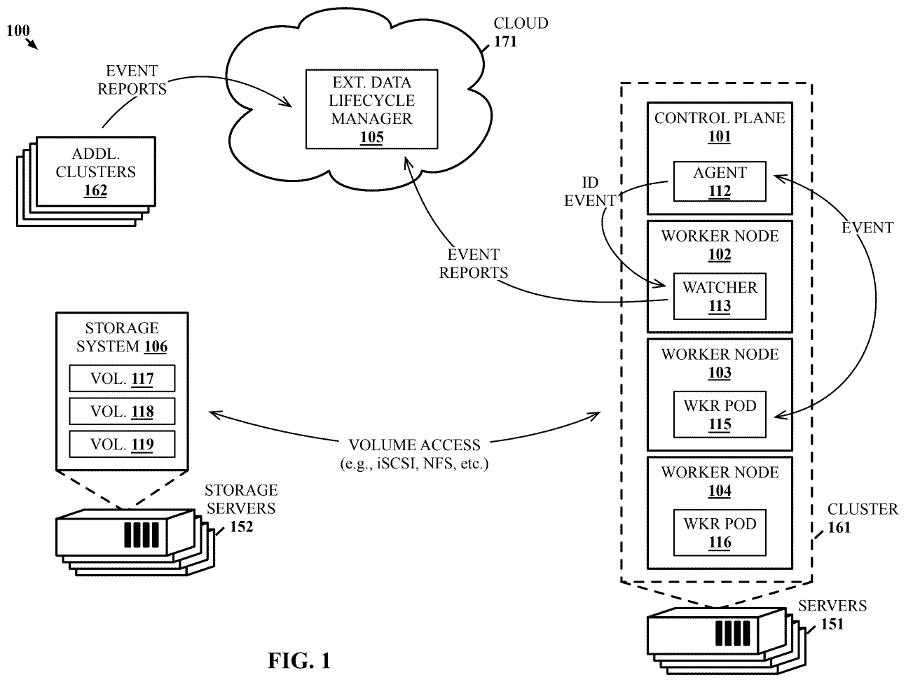

FIG. 1 illustrates implementation 100 for synchronizing resource information between a computing cluster and an external data lifecycle manager. Implementation 100 includes control plane 101, worker nodes 102-104, storage system 106, and external data lifecycle manager 105. Control plane 101 and worker nodes 102-104 are implemented on servers 151. Storage system 106 is implemented by one or more storage servers 152. External data lifecycle manager 105 executes on one or more computing systems in computing cloud 171. A computing cloud refers to a network of remote servers hosted on the internet to store, manage, and process data, rather than using a local server or personal computer, although external data lifecycle manager 105 may not be considered in a cloud while still being external to computing clusters it handles in other examples. Likewise, one or more computing clusters handled by external data lifecycle manager 105 may be included in computing cloud 171. External data lifecycle manager 105 existence external to cluster 161 enables external data lifecycle manager 105 to also manage one or more additional clusters 162 if so desired. Although not shown, communication links and communication networks exist to connect the various components in implementation 100. The communication links may be wired and/or wireless and the communication networks may include networking devices, such as routers, switches, firewalls, and the like. The communication networks may include one or more Local Area Networks (LANs) and one or more Wide Area Networks (WANs), including the Internet.

In this example, control plane 101 and worker nodes 102-104 are hosted by servers 151 and form cluster 161. The cluster executes distributed application workloads across at least worker nodes 102-104. Other nodes may also be used in cluster 161, which may be dynamic depending on demand for the application being executed in cluster 161. Each of worker nodes 102-104 may execute on an individual server of servers 151. Control plane 101 may also execute on its own server of servers 151 or may be distributed, at least in part, across other nodes in cluster 161. Worker node 103 executes worker pod 115 and worker node 104 executes worker pod 116. Worker pod 115 and worker pod 116 may be instances of a same application process for the distributed application or may be different processes for the distributed application. While referred to as pods because pods are the smallest deployable unit of computing in a Kubernetes cluster. A pod is a group of one or more containers that share the same host system (e.g., one of servers 151), although, application processes may be structured differently when using different types of cluster orchestration platforms. For instance, the worker processes may be containers, virtual machines, native applications, or some other type of computing process. Watcher 113 may similarly be a pod or other type of process. While only one pod/process is shown executing on each node, multiple pods/processes may be executing on individual nodes in other examples.

Storage system 106 may be a network storage system, a distributed storage system, or any other type of data storage system. In this example, storage system 106 stores data volumes 117-119 but may store additional data volumes in other examples. Cluster 161 may communicate with storage system 106 to access data of data volumes 117-119 using connections established using a protocol for volume access over TCP (Transmission Control Protocol), sometimes referred to as a storage networking protocol. A few example storage networking protocols are iSCSI (Internet Small Computer Systems Interface) NFS (Network File System), and NVMe (Nonvolatile Memory Express), although, other protocols may be used. Worker pods may execute from storage system 106 and/or operate on data stored on storage system 106. In some examples, external data lifecycle manager 105 may also communicate with storage system 106 to manage data lifecycles.

In operation, external data lifecycle manager 105 communicates with control plane 101 to take snapshots, schedule backups, or perform some other type of data lifecycle management in cluster 161. Control plane 101 may provide an API for external data lifecycle manager 105 to access control plane 101. A REST API (Representational State Transfer API) may be used in some cases. A REST API is a set of rules and conventions for building and interacting with web services. It uses standard HTTP methods like GET, POST, PUT, and DELETE to perform operations on resources, which are typically represented in formats like JSON or XML. REST APIs are designed to be stateless, meaning each request from external data lifecycle manager 105 to control plane 101 must contain all the information needed to understand and process the request. External data lifecycle manager 105 must, therefore, be aware of the state of cluster 161 to format a proper REST API request. Agent 112 is an extension defining additional APIs for performing tasks relevant to external data lifecycle manager 105. For example, agent 112 may include a Kubernetes custom resource if cluster 161 is a Kubernetes cluster. Agent 112 also maintains the state of cluster 161 such that events that affect the state can be reported by watcher 113 to external data lifecycle manager 105 to ensure the state of cluster 161 is synchronized between agent 112 and external data lifecycle manager 105.

The multi-informer configuration of implementation 100 allows significant improvement in reliability while reducing demand on communication resources when performing remote data lifecycle management. For instance, external data lifecycle manager 105 no longer needs to maintain active connections with a cluster to perform snapshots, backups, and other operations. Instead, external data lifecycle manager 105 only need establish communication intermittently (e.g., briefly) with watcher 113 on cluster 161 to synchronize the current state of cluster 161. Similarly, when external data lifecycle manager 105 is affecting a change to the state, external data lifecycle manager 105 communicates that the change is desired to agent 112 and allows agent 112 to handle any tasks in cluster 161 needed to implement the change. With agent 112 handling the tasks, external data lifecycle manager 105 does not need to maintain an open connection with cluster 161 to manage the tasks remotely. Event reports from watcher 113 notify external data lifecycle manager 105 when the tasks have been completed.

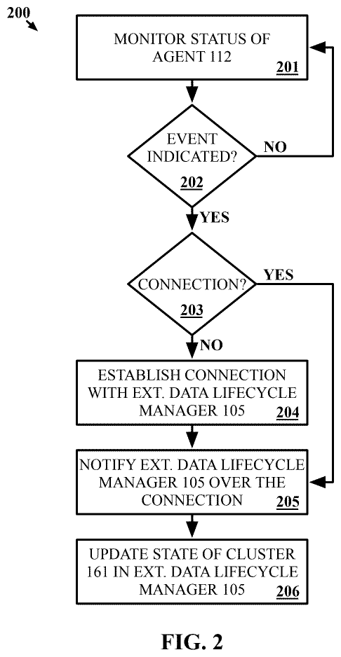

FIG. 2 illustrates operation 200 to synchronize resource information between a computing cluster and an external data lifecycle manager. In operation 200, watcher 113 monitors the status of agent 112 to identify when an event affecting the state of cluster 161 has occurred (step 201). For example, watcher 113 may be monitoring to see whether a new resource has been created, such as a snapshot, backup, new worker pod, etc., a resource has been removed, or some other information that would be relevant to managing data lifecycle in cluster 161. Watcher 113 may register event handlers with agent 112. Each event handler corresponds to a specific type of event that may be of interest to external data lifecycle manager 105. For example, watcher 113 may register add, update, and delete event handlers. As such, whenever one of those events occurs, agent 112 notifies watcher 113 about the events. The notification not only indicates that an event occurred but also information about the event. For instance, the notification may identify a resource involved in the event (e.g., an identifier for a resource being added, deleted, or modified) such that external data lifecycle manager 105 can properly update the state of cluster 161 when notified. The event may have been initiated by external data lifecycle manager 105 or may have been initiated with control plane 101 from some other source (e.g., direct user interaction with control plane 101). Watcher 113 continues to monitor agent 112 until an event is identified (step 202).

In response to identifying an event, watcher 113 determines whether a connection to external data lifecycle manager 105 is open (step 203). The connection may be a connection in any type of networking protocol enabling watcher 113 to send messages notifying external data lifecycle manager 105 about identified events. With this configuration, no permanent connection needs to be maintained with external data lifecycle manager 105 to allow for more efficient use of the connection resources when watcher 113 has nothing to report. However, it is possible that a connection still exists (e.g., has yet to be taken down) from a previous event report from watcher 113. Thus, if such a connection still exists, watcher 113 may skip establishing a connection. If a connection does not exist, then watcher 113 establishes a connection with external data lifecycle manager 105 (step 204). Watcher 113 may perform a connection handshake in accordance with a protocol used for the connection.

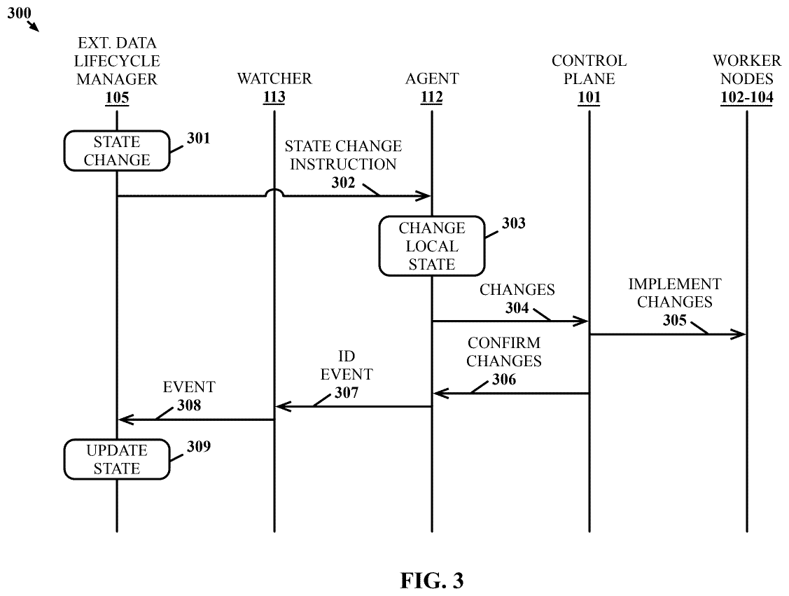

Over the established connection, watcher 113 notifies external data lifecycle manager 105 about the identified event over the connection (step 205). For example, watcher 113 may transmit a message over the connection identifying a resource involved in the event and the event that occurred. After notifying external data lifecycle manager 105, the connection between watcher 113 and external data lifecycle manager 105 may be taken down to free up the connection resources for use elsewhere. Upon being notified about the event, external data lifecycle manager 105 updates its locally managed state indicator (e.g., state database) of cluster 161's state to reflect the occurrence of the event (step 206). For example, if the event notification indicates a specified resource has been deleted, then external data lifecycle manager 105 may delete an entry for the specified resource in a state database at external data lifecycle manager 105 or otherwise indicate in the database that the specified resource has been deleted. Thus, while agent 112 was already aware of the state of cluster 161 when the event occurred, external data lifecycle manager 105 now has the same awareness of the state of cluster 161 without requiring a full time connection therewith. Watcher 113 may then continue to monitor the status of agent 112 at step 201 to ensure events continue to be identified to update external data lifecycle manager 105. FIG. 3 illustrates operational scenario 300 for synchronizing resource information between a computing cluster and an external data lifecycle manager. Operational scenario 300 is an example where the event identified by watcher 113 is initiated by external data lifecycle manager 105. Even though external data lifecycle manager 105 initiated the event, since external data lifecycle manager 105 is in computing cloud 171 outside of cluster 161, external data lifecycle manager 105 would have to assume the state change is implemented in cluster 161 without confirmation of that fact. Watcher 113 performing operation 200 can provide the confirmation to external data lifecycle manager 105.

In operational scenario 300, external data lifecycle manager 105 updates its locally managed state indicator to indicate a change in a state of cluster 161 (step 301). The locally managed state indicator at external data lifecycle manager 105 indicates the current state of resources of cluster 161 as known by external data lifecycle manager 105 (or as external data lifecycle manager 105 intends the state to be, as is the case here with external data lifecycle manager 105 attempting to affect the change). The state change may be made by a user interfacing with external data lifecycle manager 105, may be made using an internal logic of external data lifecycle manager 105, or may be caused by some other source. The state change may be the result of adding a resource, updating a resource, deleting a resource, or otherwise modifying a resource in cluster 161. For example, the state change may clone, replicate, or backup a pod or data volume in cluster 161, which constitutes the creation of a new resource. A resource of a Kubernetes cluster may be a pod, persistent volume, snapshot, backup, or some other element relevant to data lifecycle management.

External data lifecycle manager 105 contacts agent 112 with an instruction to update the state of cluster 161 in accordance with the change made to the cluster state at external data lifecycle manager 105 (step 302). Since external data lifecycle manager 105 does not require a constant connection with agent 112, external data lifecycle manager 105 may establish the connection in response to the state change being made thereat. Like the connection between external data lifecycle manager 105 and watcher 113, the connection between external data lifecycle manager 105 and agent 112 may use any protocol capable of sending the information necessary for agent 112 to cause the state change in cluster 161. The state change instruction may be an explicit instruction to change the state at cluster 161 or the state change instruction may be implicit by indicating the state has changed at external data lifecycle manager 105 and relying on agent 112 to perform the necessary tasks to make the state of cluster 161 match.

In response to receiving the state change instruction from external data lifecycle manager 105, agent 112 updates its own locally manages state of cluster 161 to reflect the state change from external data lifecycle manager 105 (step 303). Agent 112 further communicates with control plane 101 (step 304) to direct control plane 101 to implement the changes necessary to change the state of cluster 161 (step 305). For example, agent 112 may use kubctl messages with configuration files (e.g., files written in YAML) to direct control plane 101 to implement the desired state changes. The files and/or message may be created by external data lifecycle manager 105 and received during step 302 or agent 112 may compile the messages and instructions itself.

Control plane 101 responds to agent 112 to confirm the changes have been implemented (step 306). Although, in other examples, it may be possible for an error to occur when implementing the changes and control plane 101 may similarly report that error such that agent 112 can inform external data lifecycle manager 105 about the error so that external data lifecycle manager 105 does not assume the state changes have been implemented. Similarly, while agent 112 already updated a state indicator at step 303, agent 112 may wait to update the state indicator until confirmation is received that the changes have been implements. Alternatively, the state indicator may first be updated to indicate the change is pending and then updated again upon receiving confirmation that the changes have been made and are no longer pending. Watcher 113 identifies the event having occurred after agent 112 receives confirmation from control plane 101 (step 307). Watcher 113 may identify the event with an event handler associated with the event reporting the event has occurred like in step 202 of operation 200. Watcher 113 establishes a connection with external data lifecycle manager 105, if a connection does not already exist, and notifies external data lifecycle manager 105 about the event (step 308). External data lifecycle manager 105 then updates its state indicator for cluster 161 to reflect that the event has occurred (step 309).

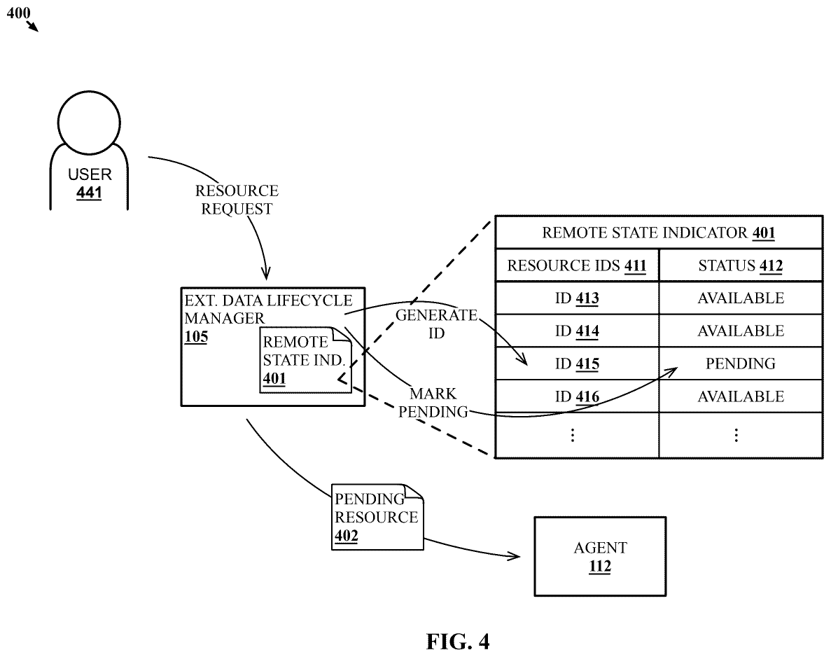

FIG. 4 illustrates operational scenario 400 for synchronizing resource information between a computing cluster and an external data lifecycle manager. Operational scenario 400 includes an example of how state indicators may be updated locally in cluster 161 and in external data lifecycle manager 105 to reflect state changes. In operational scenario 400, user 441 determines a new resource is desired in cluster 161. For example, user 441 may be an administrator of cluster 161 and user 441 may be requesting a snapshot be made of another resource in cluster 161 (e.g., a snapshot of worker pod 116). External data lifecycle manager 105 maintains remote state indicator 401 in local memory. Remote state indicator 401 is a database of resource identifiers 411 and corresponding resource status 412 of the resources identified by resource identifiers 411. Remote state indicator 401 is shown as a table but may take other forms and include other information than that included in this example. For instance, remote state indicator 401 may include a column defining a type of resource (e.g., snapshot, clone, etc.).

Prior to receiving the resource request from user 441, remote state indicator 401 included resource identifier 413, resource identifier 414, and resource identifier 416, which are all indicated as being available or active. Additional resources may be identified in remote state indicator 401. External data lifecycle manager 105 generates resource identifier 415 to uniquely identify the new resource from amongst other resources in cluster 161. The resource may be a random or arbitrary string of characters, may be generated using a transform (e.g., a hash function using characteristics of the resource as input), or may be created using some other mechanism. In some examples, the cluster orchestration platform of cluster 161 may define how the identifiers should be generated. This ensures the identifiers can be used in the cluster itself and not just for the purposes of external data lifecycle manager 105. In such cases, no translation between identifiers used in cluster 161 and those used in remote state indicator 401 will be needed.

An entry in remote state indicator 401 for the new resource is created with resource identifier 415 for the new resource and corresponding resource status 412 being pending. The new resource is marked as pending because, at this point, nothing in cluster 161 is aware of the desire to create the new resource much less have the new resource exist in cluster 161. The pending status enables the new resource to be actionable (e.g., referenced for further actions to be taken with the resource) but those action cannot be taken until the resource is available. To initiate the creation of external data lifecycle manager 105, external data lifecycle manager 105 transmits pending resource indicator 402 over a connection with agent 112 at cluster 161. May be transmitted at the request of agent 112 (e.g., agent 112 may periodically request external data lifecycle manager 105 to provide all pending resources) or external data lifecycle manager 105 may push pending resources to agent 112.

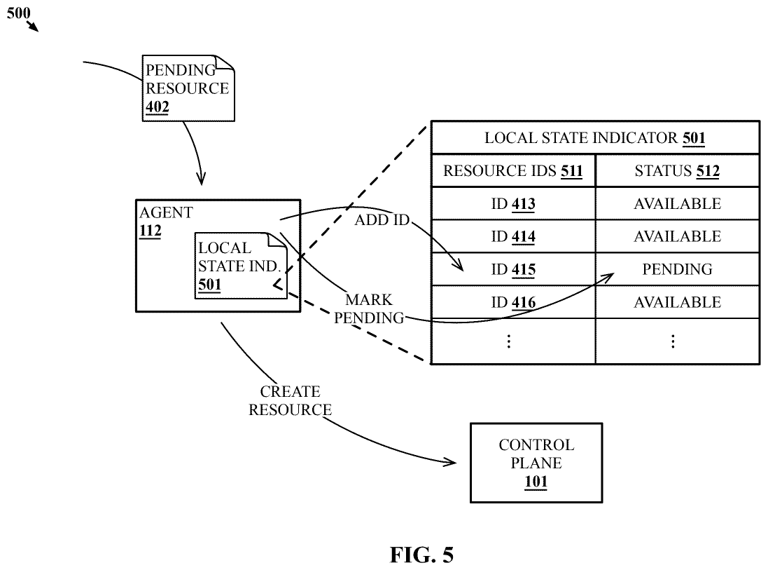

FIG. 5 illustrates operational scenario 500 for synchronizing resource information between a computing cluster and an external data lifecycle manager. Operational scenario 500 is a continuation of operational scenario 400. As shown, operational scenario 500 includes agent 112 receiving pending resource indicator 402 from external data lifecycle manager 105. Agent 112 maintains local state indicator 501, which is similar to remote state indicator 401 such that remote state indicator 401 and local state indicator 501 can synchronize resources identified therein. Like remote state indicator 401, local state indicator 501 includes a column for resource identifiers 511 and resource status 512. Pending resource indicator 402 indicates that a new resource with resource identifier 415 is pending. In this example, pending resource indicator 402 may indicate that the new resource is to be a snapshot of another resource so that agent 112 knows what needs to be performed to create the new resource. Prior to receiving pending resource indicator 402, local state indicator 501 included resource identifier 413, resource identifier 414, and resource identifier 416 with corresponding resource status 512 indicating that all three are available. Like external data lifecycle manager 105 did with remote state indicator 401, agent 112 adds resource identifier 415 to local state indicator 501 with a corresponding resource status 412 of pending. At this point, local state indicator 501 and remote state indicator 401 are synchronized with the same resource identifiers and corresponding statuses.

Also, upon receiving pending resource indicator 402, agent 112 interfaces with control plane 101 to create the new resource with resource identifier 415. For example, agent 112 may instruct control plane 101 to take a snapshot of worker pod 116. This may involve control plane 101 communicating with storage system 106 to snapshot one or more of data volumes 117-119 corresponding to worker pod 116.

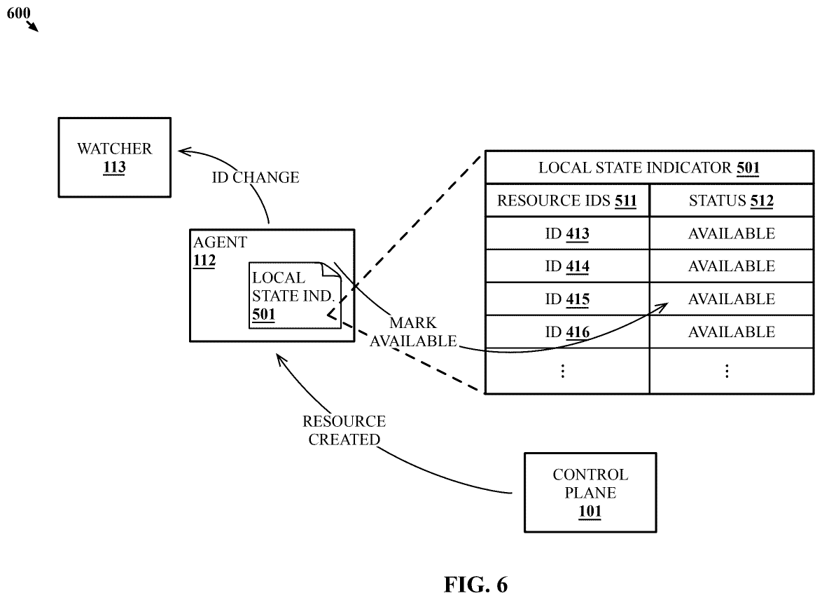

FIG. 6 illustrates operational scenario 600 for synchronizing resource information between a computing cluster and an external data lifecycle manager. Operational scenario 600 is a continuation of operational scenario 400. In operational scenario 600, control plane 101 confirms the actions directed by agent 112 to create the new resource have been completed and the resource is now available. As such, agent 112 updates the entry with resource identifier 415 in local state indicator 501 to mark the resource as being available rather than pending. Watcher 113 recognizes the change from pending to available for resource identifier 415 as an event change.

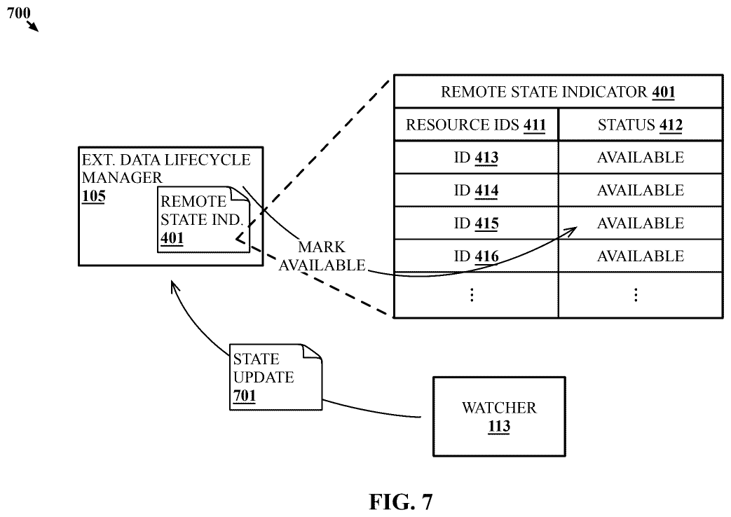

FIG. 7 illustrates operational scenario 700 for synchronizing resource information between a computing cluster and an external data lifecycle manager. Operational scenario 700 is a continuation of operational scenario 600. After identifying the change of resource identifier 415 to available, watcher 113 sends state update 701 to external data lifecycle manager 105. State update 701 indicates that the resource with resource identifier 415 is now available. As such, external data lifecycle manager 105 updates remote state indicator 401 by marking the entry in remote state indicator 401 for resource identifier 415 as being available. Remote state indicator 401 and local state indicator 501 are now synchronized with the same status information for the resources in cluster 161.

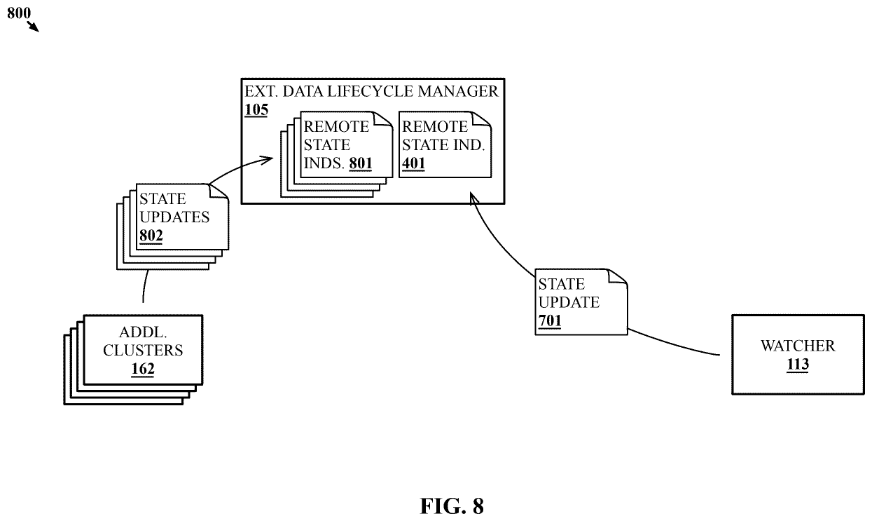

FIG. 8 illustrates operational scenario 800 for synchronizing resource information between a computing cluster and an external data lifecycle manager. In operational scenario 800, external data lifecycle manager 105 is the data lifecycle manager for multiple clusters, cluster 161 and one or more of additional clusters 162. Cluster 161 and additional clusters 162 may operate on behalf of a single entity or may be operated by at least two different entities. The cloud-based nature of external data lifecycle manager 105 enables cluster 161 and additional clusters 162 to be positioned in different geographic locations while still being managed by a single data lifecycle manager over the Internet. Like in the examples above, external data lifecycle manager 105 will manage a state indicator for each of the clusters external data lifecycle manager 105 is tasked with handling. For example, while remote state indicator 401 receives state update 701, external data lifecycle manager 105 similarly receives state updates 802 informing external data lifecycle manager 105 about events that occur in additional clusters 162. External data lifecycle manager 105 updates ones of remote state indicators 801 maintained for respective ones of additional clusters 162 in accordance with the state updates 802. As such, external data lifecycle manager 105 maintains an individual remote state indicator for each cluster for which external data lifecycle manager 105 is handling data lifecycle management. External data lifecycle manager 105 may also be able to initiate resource changes in additional clusters 162 in the manners described in operational scenarios 300-700.

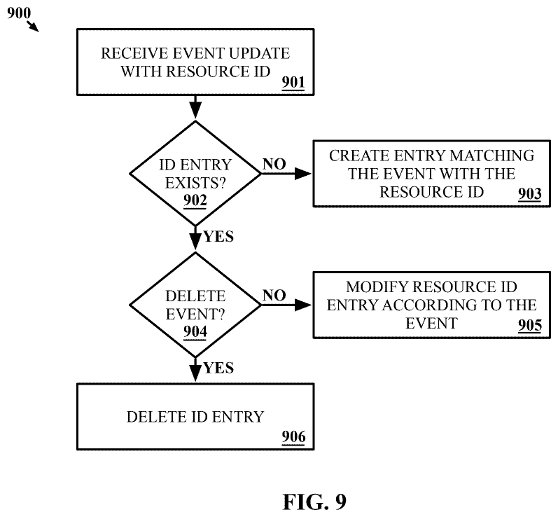

FIG. 9 illustrates operation 900 to synchronize resource information between a computing cluster and an external data lifecycle manager. Operation 900 in an example for how external data lifecycle manager 105 may update remote state indicator 401 when an event update notification is received from watcher 113 (step 901). The received event update includes a resource identifier used in cluster 161. External data lifecycle manager 105 determines whether an entry exists in remote state indicator 401 having the resource identifier (step 902). If no entry exists for the resource identifier, external data lifecycle manager 105 creates an entry in remote state indicator 401 with the resource identifier in resource identifiers 411 (step 903). The entry further indicates the status of the identified resource in resource status 412 as well as any other information that may be tracked by remote state indicator 401 and included in the event update. While only two potential states have been discussed thus far, available and pending, more possible states may exist, such as ready, active, standby, etc. When an entry does not yet exist in remote state indicator 401, it is likely that the resource was created by control plane 101 independent of instruction from external data lifecycle manager 105 (e.g., an administrator may direct control plane 101 to execute additional workload pods to handle workload demand and the resource may be one of those new pods).

If an entry does already exist for the indicated identifier, external data lifecycle manager 105 determines what the update entails. Specifically, external data lifecycle manager 105 determines whether the event is an event deleting the identified resource (step 904). If not a delete event, then external data lifecycle manager 105 modifies the entry in remote state indicator 401 in accordance with the event (step 905). For example, the event update may indicate that the status of the resource has changed (e.g., from pending to available or from standby to active). External data lifecycle manager 105 then updates the resource status 412 to reflect the new state. Other information maintained by remote state indicator 401 may also, or instead, be updated as indicated by the received update. But, if the event update is a delete event, then external data lifecycle manager 105 deletes the entry for the resource from remote state indicator 401 (step 906). After deletion, remote state indicator 401 no longer has an entry for the identified resource to match cluster 161 no longer having the resource.

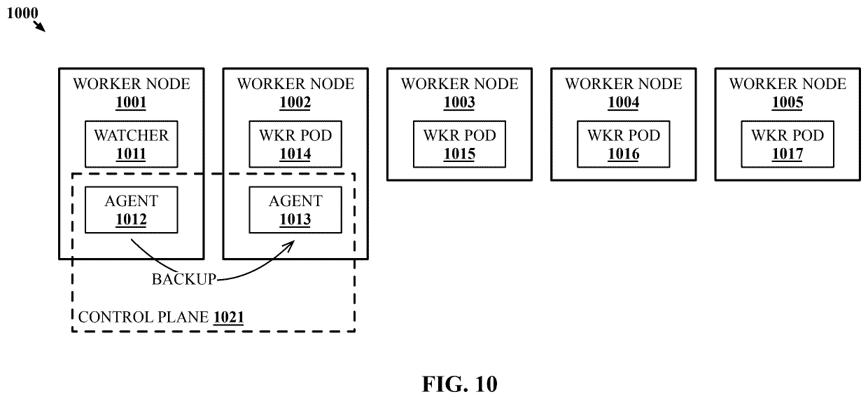

FIG. 10 illustrates computing cluster 1000 for synchronizing resource information between a computing cluster and an external data lifecycle manager. Computing cluster 1000 may be a cluster in additional clusters 162 or may be an alternative configuration of cluster 161. As such, although servers like servers 151 are not shown, worker nodes 1001-1005 are hosted by respective servers. In this example, worker node 1001 executes watcher 1011 while worker nodes 1002-1005 execute worker pods 1014-1017, respectively. In other examples, worker nodes 1001-1005 may execute more than one pod.

Worker node 1001 further executes agent 1012 while worker node 1002 executes agent 1013. Agents 1012 and 1013, like agent 112, may include Kubernetes custom resources and custom controllers, and are part of control plane 1021 for computing cluster 1000. Control plane 1021 includes more control processes that are not shown. Control plane 1021 may execute process on a server dedicated to control plane 1021. At least a portion of the processes may be distributed across one or more of worker nodes 1001-1005.

In a Kubernetes-focused example of computing cluster 1000, watcher 1011 may be a second informer in addition to a default informer already employed by Kubernetes in computing cluster 1000. Agent 1012 and agent 1013 may both include Kubernetes custom resources that the second informer is tasked with monitoring. Given the efficient event-based nature of informers where watcher 1011 only needs to use network/processing resources to report events in a monitored custom resource when they occur, watcher 1011 uses a negligible amount of resources relative to examples where external data lifecycle manager 105 would have to maintain a constant connection with computing cluster 1000 to identify events. When watcher 1011 identifies an event in agent 1012 or agent 1013, watcher 1011 reports that event to external data lifecycle manager 105. External data lifecycle manager 105 can then determine whether to accept or deny a change in computing cluster 1000 caused by the event.

Custom resources and controllers like agent 1012 and agent 1013 further allow external data lifecycle manager 105 to perform data lifecycle management functions, such as snapshot, backups, etc., without maintaining an active connection to perform those functions. Instead, external data lifecycle manager 105 communicates briefly with an active one of agent 1012 and agent 1013 to instruct the agent to perform a task. The agent receiving the instruction then implements the logic in computing cluster 1000 necessary to perform the task without further input from external data lifecycle manager 105, allowing the task to be completed even in situations where a loss of connection with external data lifecycle manager 105 would occur.

Furthermore, as suggested by the existence of multiple agents 1012 and 1013 in this example, the distribution of data lifecycle management functionality between external data lifecycle manager 105 and a custom resource (i.e., agent 1012 or agent 1013) in computing cluster 1000 enables a High-availability (HA) configuration for the custom resources in computing cluster 1000. External data lifecycle manager 105 can direct an agent to back up another agent, as agent 1012 is directed to backup agent 1013 in operational scenario 1100 below. If there happen to be other custom resources used by external data lifecycle manager 105 in computing cluster 1000, agent 1012 may be directed to backup those resources as well and one of the other custom resources may be instructed to backup agent 1012. Should computing cluster 1000 need to be recreated (e.g., after a failure) or duplicated, a most recent back up of agent 1013 would be selected for the restored cluster along with backups identified by agent 1013 for applications (e.g., pods), application namespaces, and resources from storage system 106 pointed to by the backup in storage system 106. As such, a separate external backup controller is not needed.

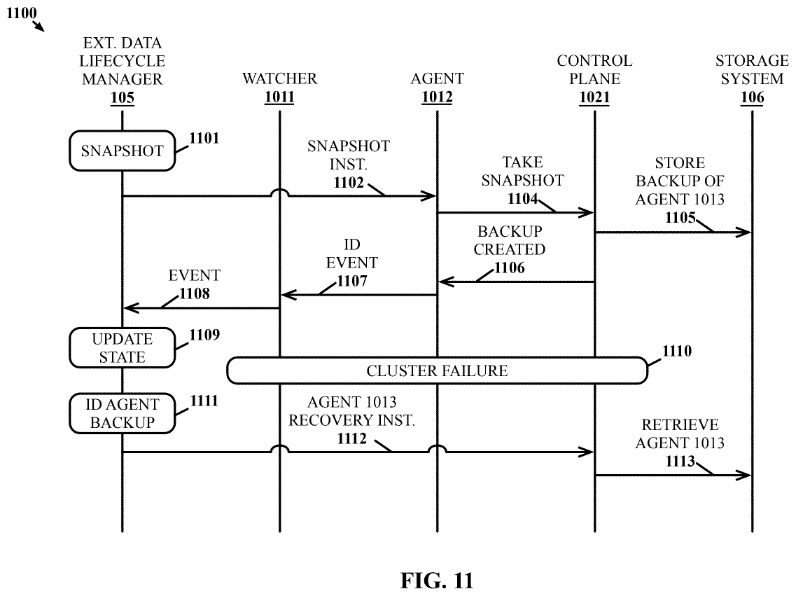

FIG. 11 illustrates operational scenario 1100 for synchronizing resource information between a computing cluster and an external data lifecycle manager. Operational scenario 1100 is an example for how agent 1013 is created to backup agent 1012. In operational scenario 1100, external data lifecycle manager 105 determines a snapshot should be created of agent 1013 (step 1101). A user may instruct external data lifecycle manager 105 to create the snapshot, external data lifecycle manager 105 may determine that a new snapshot of agent 1013 should be created periodically, conditions may exist in computing cluster 1000 indicating that a snapshot should be created, or some other trigger may cause external data lifecycle manager 105 to determine a snapshot should be created.

External data lifecycle manager 105 instructs agent 1012 to create a snapshot of agent 1013 (step 1102). The snapshot instruction may happen in a manner similar to that shown in operational scenario 400 with external data lifecycle manager 105 creating a new entry for the snapshot in a remote state indicator for computing cluster 1000 and marking the new entry as pending before notifying agent 1012 of the pending resource. In response to receiving the instruction, agent 1012 instructs control plane 1021 to take the snapshot (step 1104). For this example, control plane 1021 takes the snapshot of agent 1013 and stores the snapshot as a backup of agent 1013 in a storage volume of storage system 106 (step 1105). Control plane 1021 confirms when the snapshot is completed (step 1106). Watcher 1011 identifies the creation event for the snapshot of agent 1013 from agent 1012 (step 1107) and notifies external data lifecycle manager 105 about the event (step 1108). Upon receiving the event notification, external data lifecycle manager 105 updates the remote state indicator for computing cluster 1000 to indicate that the snapshot of agent 1013 now exists (step 1109).

At a time after agent 1013 is created, computing cluster 1000 fails (step 1110). In some cases, this may be caused by the hardware (e.g., computing servers executing computing cluster 1000) failing. Upon recognizing the failure of computing cluster 1000, external data lifecycle manager 105 identifies the most recent backup of agent 1013 to restore agent 1013 to a restored version of computing cluster 1000 (step 1111) The restored version of computing cluster 1000 may execute on the same hardware or may execute on different computing hardware from the original computing cluster 1000. External data lifecycle manager 105 instructs control plane 1021 for the restored version of computing cluster 1000 to recover agent 1013 from the backup created at step 1105 (step 1112). The instruction from external data lifecycle manager 105 may indicate where the snapshot of agent 1013 is stored in storage system 106, may indicate a worker node in computing cluster 1000 to which agent 1013 should be restored, or may provide some other information control plane 1021 may use to recover agent 1013. In response to the instruction from external data lifecycle manager 105, control plane 1021 retrieves the snapshot of agent 1013 from storage system 106 and executes agent 1013 in the restored version of computing cluster 1000 (step 1113). The information included in agent 1013 (e.g., in a local state indicator of computing cluster 1000) may then be used by control plane 1021 to restore resources of computing cluster 1000 to the new version of computing cluster 1000.

While operational scenario 1100 above focuses on agent 1012 backing up agent 1013, agent 1013 may be instructed by external data lifecycle manager 105 to backup agent 1012 as well. This allows both agent 1012 and agent 1013 to have backups ready for restoration should computing cluster 1000 fail, as occurred in operational scenario 1100.

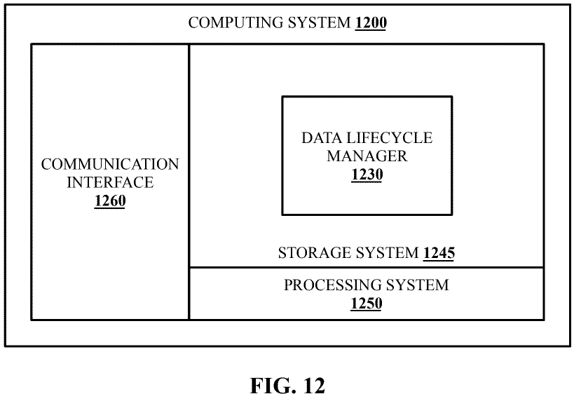

FIG. 12 illustrates a computing system 1200 for synchronizing resource information between a computing cluster and an external data lifecycle manager. Computing system 1200 is representative of any computing system or systems with which the various operational architectures, processes, scenarios, and sequences disclosed herein can be implemented. Computing system 1200 is an example architecture for data lifecycle manager 105, although other examples may exist. Computing system 1200 includes storage system 1245, processing system 1250, and communication interface 1260. Processing system 1250 is operatively linked to communication interface 1260 and storage system 1245. Communication interface 1260 may be communicatively linked to storage system 1245 in some implementations. Computing system 1200 may further include other components such as a battery and enclosure that are not shown for clarity.

Communication interface 1260 comprises components that communicate over communication links, such as network cards, ports, radio frequency (RF), processing circuitry and software, or some other communication devices. Communication interface 1260 may be configured to communicate over metallic, wireless, or optical links. Communication interface 1260 may be configured to use Time Division Multiplex (TDM), Internet Protocol (IP), Ethernet, optical networking, wireless protocols, communication signaling, or some other communication format-including combinations thereof. Communication interface 1260 may be configured to communicate with other computing systems via one or more networks.

Processing system 1250 comprises microprocessor and other circuitry that retrieves and executes operating software from storage system 1245. Storage system 1245 may include volatile and nonvolatile, removable, and non-removable media implemented in any method or technology for storage of information, such as computer readable instructions, data structures, program modules, or other data. Storage system 1245 may be implemented as a single storage device but may also be implemented across multiple storage devices or sub-systems. Storage system 1245 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1245, or any other computer-readable storage medium herein, be considered a transitory form of signal transmission (often referred to as “signals per se”), such as a propagating electrical or electromagnetic signal or carrier wave.

Processing system 1250 is typically mounted on a circuit board that may also hold the storage system. The operating software of storage system 1245 comprises computer programs, firmware, or some other form of machine-readable program instructions. The operating software of storage system 1245 comprises data lifecycle manager module 1230. The operating software on storage system 1245 may further include an operating system, utilities, drivers, network interfaces, applications, or some other type of software. When read and executed by processing system 1250 the operating software on storage system 1245 directs computing system 1200 to manage data lifecycles as described herein. Data lifecycle manager module 1230 may execute natively on processing system 1250 or the operating software may include virtualization software, such as a hypervisor, to virtualize computing hardware on which data lifecycle manager module 1230 executes.

In at least one example, data lifecycle manager module 1230 executes on processing system 1250 and directs processing system 1250 to receive a resource change for the cluster from a user. The resource change adds a new resource to the cluster. Data lifecycle manager module 1230 also directs processing system 1250 to generate an identifier for the new resource that identifies the new resource relative to other resources associated with other identifiers and associate the identifier with the new resource in an entry of a cloud state database storing a state of the cluster. The entry indicates the new resource is pending. Data lifecycle manager module 1230 further directs processing system 1250 to synchronize the cloud state database with a local state database maintained by an agent in the cluster. The agent performs tasks in the cluster to create the new resource having the identifier in the cluster. After the new resource is created, data lifecycle manager module 1230 directs processing system 1250 to again synchronize the cloud state database with the local state database to update the entry to indicate the new resource is no longer pending.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for data lifecycle management for nodes in a cluster of a distributed application environment, the method comprising:
executing an agent of the data lifecycle manager on a node of nodes in the cluster;
executing a watcher of a control plane of the distributed application environment to monitor events for resources in the cluster;
after identifying at least one of the events, establishing a connection between the watcher and a data lifecycle manager that is external to the cluster; and
transmitting a notification about the events from the watcher to the data lifecycle manager over the connection, wherein the data lifecycle manager handles data lifecycle management in the cluster based on the notification.

2. The method of claim 1, comprising:
transmitting a data management instruction from the data lifecycle manager to the agent; and
in response to receiving the data management instruction, performing, by the agent independent from the data lifecycle manager, tasks within the cluster to handle the data management instruction.

3. The method of claim 2, comprising:
establishing a second connection between the agent and the data lifecycle manager over which the data management instruction is transmitted, wherein the connection has ended when the data management instruction is transmitted.

4. The method of claim 2, comprising:
in the data lifecycle manager:
receiving a change to a state of the cluster from a user;
updating a remote state indicator of the state of the cluster maintained by the data lifecycle manager to include the change; and
generating the data management instruction to affect the change in the cluster; and
in the agent, updating a local state indicator of the state.

5. The method of claim 4, wherein the change comprises an additional resource in the cluster, and the method comprising:
generating an identifier for the additional resource for inclusion in the remote state indicator comprising a databased of resource identifiers for resources in the cluster;
wherein the identifier identifies the additional resource relative to others of the resources in the cluster.

6. The method of claim 5, comprising:
in the watcher, monitoring for when an event indicates the additional resource has been created in the cluster; and
transmitting a message from the watcher to the data lifecycle manager, wherein the remote state indicator is updated in response to receiving the message.

7. The method of claim 6, comprising:
in the data lifecycle manager, before receiving the message from the watcher, including in the remote state indicator an indication that the change is pending;
wherein updating the remote state indicator includes removing the indication that the change is pending.

8. The method of claim 4, comprising:
in the agent, updating the local state indicator to indicate the resource has been created in the cluster.

9. The method of claim 7, wherein transmitting the data management instruction comprises:
receiving a request for pending resources from the remote state indicator; and
transmitting the indication that the change is pending, wherein the agent recognizes the change being pending as the data management instruction to make the change.

10. The method of claim 1, comprising:
removing the connection after the notification is transmitted and no further communications are pending.

11. The method of claim 1, comprising:
executing a second instance of the agent on a second node of the nodes in the cluster; and
enabling a high availability configuration for functionality of the agent between the node and the second node.

12. The method of claim 11, wherein the second instance is a backup to the agent, and the method comprising:
generating, at the second instance, a snapshot of the agent; and
recovering a state of the agent from the snapshot upon determining the agent has failed.

13. A system for data lifecycle management for nodes in a cluster of a distributed application environment, the system comprising:
the nodes in the cluster configured to execute pods managed by a Kubernetes installation for an application in the distributed application environment;
a node of the nodes in the cluster configured to execute a watcher for a data lifecycle manager based in a cloud external to the cluster;
a pod executing in the nodes as an agent of the data lifecycle manager;
the agent configured to:
determine a cloud state of the cluster at the data lifecycle manager indicates a resource in the cluster is pending; and
perform tasks in the cluster to create the resource; and
the watcher configured to:
determine a local state of the cluster maintained by the agent indicates the resource is in the cluster; and
notify the data lifecycle manager that the resource exists in the cluster.

14. The system of claim 13, comprising the watcher configured to:
monitor the agent for other updates to the local state of the cluster; and
notify the data lifecycle manager about the other updates, wherein the data lifecycle manager updates the cloud state of the cluster to reflect the updates.

15. The system of claim 13, wherein:
to determine the cloud state of the cluster indicates the resource is pending, the agent is configured to request a list of pending resource changes from the data lifecycle manager, wherein the resource is included in the list and wherein the resource is identified by a resource identifier unique relative to other resource identifiers for other resources in the cluster.

16. The system of claim 13, comprising the agent configured to:
update the local state of the cluster to indicate the resource is in the cluster, wherein the data lifecycle manager updates the cloud state of the cluster to indicate the resource is no longer pending upon being notified that the resource exists in the cluster.

17. The system of claim 13, comprising:
the agent configured to establish a first connection with the data lifecycle manager over which the cloud state of the cluster is determined; and
the watcher configured to, after the first connection is ended, establish a second connection over which the data lifecycle manager is notified that the resource exists in the cluster.

18. An apparatus for data lifecycle management for nodes in a cluster of a distributed application environment, the apparatus comprising:
one or more computer readable storage media;
one or more processing systems operatively coupled with the one or more computer readable storage media; and
program instructions stored on the one or more computer readable storage media that, when read and executed by the processing system, direct the apparatus to:
receive a resource change for the cluster from a user, wherein the resource change adds a new resource to the cluster;
associate an identifier with the new resource in an entry of a cloud state database storing a state of the cluster, wherein the entry indicates the new resource is pending;
synchronize the cloud state database with a local state database maintained by an agent in the cluster, wherein the agent directs the cluster to perform tasks to create the new resource having the identifier in the cluster; and
after the new resource is created, again synchronize the cloud state database with the local state database to update the entry to indicate the new resource is no longer pending.

19. The apparatus of claim 18, wherein to again synchronize the cloud state database with the local state database, the program instructions direct the apparatus to:
receive an updated entry from the local state database indicating the new resource exists in the cluster;
determine an entry identifier from the updated entry matches the identifier; and
changing the entry in the cloud state database to reflect the updated entry.

20. The apparatus of claim 18, wherein the program instructions direct the apparatus to:
synchronize additional cloud state databases with respective local state databases maintained by additional agents in additional clusters.
